(19) United States
(12) Patent Application Publication
(10) Pub. No.: US 2005/0021637 A1
(43) Pub. Date: Jan. 27, 2005

(54) Electronic mail control system

(75) Inventor: Alan Cox, Swansea (GB)

Correspondence Address: WILMER CUTLER PICKERING HALE AND DORR LLP, 60 STATE STREET, BOSTON, MA, 02109, US

(73) Assignee: Red Hat, Inc., Research Triangle Park, NC (US)

(21) Appl. No.: 10/624,445

(22) Filed: Jul. 22, 2003

(51) Int. Cl. G06F 15/173; G06F 15/16

(52) U.S. Cl. 709/206; 709/225

(57) ABSTRACT

An electronic mail system provides one or more approvers with approval authority over electronic mail of a user. The approvers have the opportunity to approve an incoming electronic mail message before the message is delivered to the user, and have the opportunity to approve an outgoing electronic mail message by the user before the message is sent to its intended recipient. Messages can be approved or rejected automatically, using filters, or through actions by an approver. Rejected incoming messages are not delivered to the user. Rejected outgoing messages are not sent to the intended recipient. Mail to be approved can be synchronized for consistency among multiple approvers. The user whose mail is to be approved can access the mail from multiple locations, with the mail at each location synchronized to appear in the same folders.

### FIELD OF THE INVENTION

This invention relates to electronic mail systems and, more particularly, to electronic mail systems accessible to multiple users.

### BACKGROUND OF THE INVENTION

Electronic mail has become an important means for communicating in business and other contexts. Users often have multiple devices for accessing electronic mail, including one or more computers and an array of wireless devices. In addition, users may have the ability to access electronic mail from devices they do not own or control. Users want to be able to access their electronic mail from any device.

With many existing electronic mail systems, electronic mail messages are downloaded to the device on which the message is read or information about the message is maintained on the device. Thus, information about a particular message may be located on multiple devices in multiple locations. A particular device may not be on the network or accessible to other devices at any given time.

In addition, multiple users may have access to a single electronic mail account. Often, it would be desirable for at least some of the actions taken by each user to be consistent or for some users to be able to determine if other users have read or otherwise acted upon certain electronic mail messages.

A variation on the multiple user situation exists with systems that provide control over incoming and/or outgoing electronic mail. An example of such systems is a parental control system, in which filters are used to block certain electronic mail from reaching children, although such systems could be used in other contexts. To work adequately, parental electronic mail control systems should block objectionable mail messages but permit unobjectionable messages to pass through. Often, such filters need to be fine-tuned based on the particular user and on what is considered to be objectionable. Obtaining results in which objectionable messages are blocked but unobjectionable messages are not blocked can be difficult. Successful filtering can be particularly difficult in a multi-lingual environment.

### SUMMARY OF THE INVENTION

Instead of, or in addition to, the filters used in present mail filtering systems, the present invention uses a mail system in which a child (or other person subject to the controls) receives electronic mail messages only once they have been approved by a parent (or other person who is permitted to exercise the control). Multiple people can have approval authority, and the actions taken by each approver can be synchronized. The invention can be applied in situations in which a child (or other person) has multiple mail-reading locations, so that the child's mail appears the same from all locations. If desired, certain messages can be approved or blocked automatically using mail filters. In addition, one or more of the approvers can be notified automatically if a new message is received or has not been reviewed after a particular period of time.

In some embodiments, mail to a child or similar user initially is stored in an unapproved mail area. While in this area, the mail can be approved or deleted by anyone authorized to do so, but is not accessible by the child. If approved, the message is moved to an approved mail area, which serves as an unread messages folder or inbox for the child. The child can then move the mail to other folders, as desired.

If more than one person has approval authority or the unapproved messages can be accessed from multiple devices, then each such person or device can have access to the messages in the unapproved mail area. In some embodiments, approval by any one approver causes the message to be moved to the child's unread messages folder. Then, after synchronizing the mail areas of the approvers, the second approver would no longer need to review that message. If different approvers take different actions before their mail areas are synchronized, then the system can provide for various results, as appropriate. For example, if any approver rejects the message, it can be deleted from the child's mail folders, in some cases even if it has been read. Or, the approved message can be permitted to remain once it has been approved once. With multiple approvers or access from multiple devices, the system can prevent multiple copies of the same message from appearing in the child's unread mail folder.

In some embodiments, the actions of each approver are synchronized with other approvers so that once one approver has acted on a message, that message no longer appears in the unapproved mail area for any of the approvers. The synchronization can take place after an action has been taken, when an approver exits from the mail approval process, when an approver enters the mail approval process, or at other times.

Outgoing mail can be handled in an analogous manner. When the child sends a mail message, it is transferred initially to an unapproved folder. An approver can then move the message to an approved area, from which it would be sent to the recipient. By synchronizing messages in the approved area before they are released, the sending of multiple copies of a message can be avoided.

The present invention relates to the system for synchronizing electronic mail that is described in copending application Ser. No. 10/348,201, filed Jan. 21, 2003 by Alan Cox entitled “MAIL SYNCHRONIZATION SYSTEM,” and which is incorporated herein by reference. Like with the system described in that application, synchronization of multiple devices or multiple users can take place across multiple devices at multiple times. Particular devices do not need to connect to all other devices.

In some embodiments, each mail message is assigned a unique message identifier. When the message is moved from one folder to another folder, it is assigned a new message identifier.

### BRIEF DESCRIPTION OF THE DRAWINGS

FIG. 1 is a block diagram illustrating an example of a network with multiple devices according to an embodiment of the present invention.

FIG. 2A is a block diagram illustrating a state of mailbox folders for an approver according to an embodiment of the present invention.

FIG. 2B is a block diagram illustrating a state of mailbox folders for a child according to an embodiment of the present invention.

FIGS. 3A and 3B are block diagrams illustrating a state of the mailbox folders of FIGS. 2A and 2B after some processing of messages according to an embodiment of the present invention.

### DETAILED DESCRIPTION OF PREFERRED EMBODIMENTS

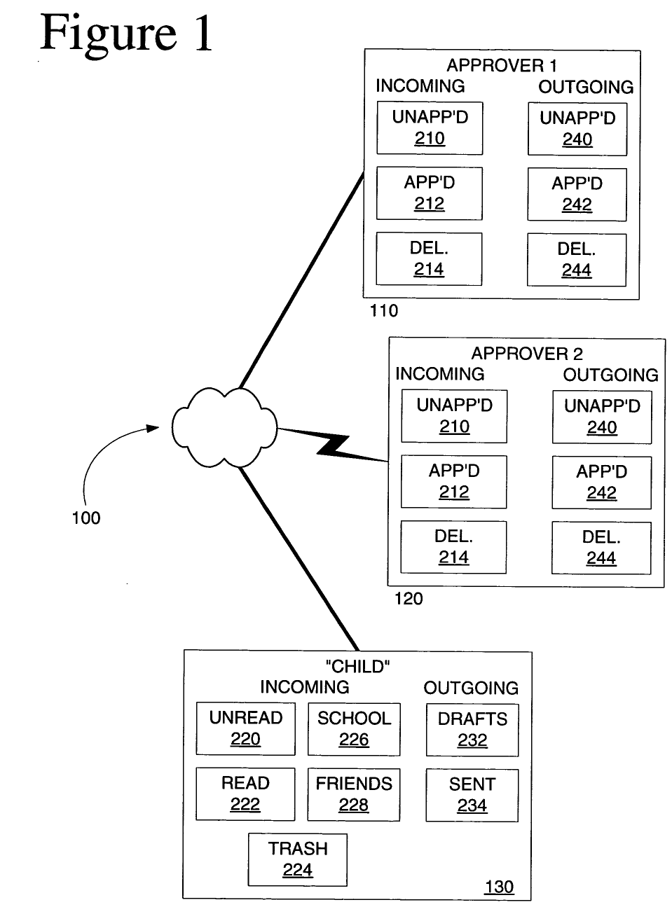

As shown in FIG. 1, network 100, which may be the Internet or some other network, includes multiple devices that can be used in connection with viewing a user's electronic mail. In this example, network 100 includes device 110, which is used by one person with approval authority, wireless device 120 (such as a wireless personal digital assistant or web-enabled cellular telephone), which is used by a second person with approval authority, and device 130, a device used by a person (in this example, a child) who needs to get electronic mail messages approved before they can be viewed. For example, the two people with approval authority may be the parents of a child using device 130. Some or all of the devices may not always be connected to the network. Although shown in FIG. 1 as separate units, devices 110 and 130 could represent different accounts on a single unit. Devices 110 and 120 may be two different devices used by two different approvers, two different devices used by the same approver, or two devices both of which either approver can access. The approvers could also have different accounts on a single unit.

Similarly, the child may have multiple locations from which to access an account (such as at home, at school, or via a wireless device). From each location, the incoming and outgoing mail can be treated the same.

The child's mail folders are depicted within device 130. In this example, the child's incoming mail messages appear initially in unread folder 220. Once read, they appear in read folder 222. If deleted, they are moved to trash folder 224. The child also has set up school folder 226 and friends folder 228, for storing messages related to school and friends, respectively. Optionally, outgoing messages that the child is preparing appear in drafts folder 232. Once the child sends the message, it appears in sent folder 234. Although represented internally as different folders, it should be understood that from the user's perspective, some of these folders may appear together. For example, both unread and read messages may appear together in an inbox. It should be understood that a folder can take numerous forms that permit the separation of mail messages.

Before a message appears in the unread folder for device 130, it must be approved. Generally, in this example, messages must be approved by one of the 2 approvers, using devices 110 or 120. However, some messages may be approved automatically using an electronic mail filter. For example, messages from certain users may be approved automatically.

Messages initially appear in the incoming unapproved folder 210. If approved, the message is moved to incoming approved folder 212. If rejected, the message is moved to incoming deleted folder 214. Some messages may be rejected automatically, using a filter.

Messages reaching incoming approved folder 212 will also appear in the child's unread folder 220. Incoming approved folder 212 and the child's unread folder 220 may represent two views of the same folder or may represent different folders, with (for example) messages automatically copied or moved from incoming approved folder 212 to unread folder 220.

Incoming deleted folder 214 and the child's trash folder 224 are distinct folders. Messages appearing in one will not appear in the other in the ordinary course.

A message that the child sends appears in sent folder 232, as with many conventional electronic mail systems. However, before the message can be delivered to the intended recipient it is copied to outgoing unapproved folder 240. The message is not delivered until it is approved, at which point it is moved to outgoing approved folder 242. If the message is not approved, it is moved instead to outgoing deleted folder 244. In some embodiments, the child is informed if a message is not approved. As with incoming messages, some messages may be approved automatically or rejected automatically, based on the results of one or more filters.

In some embodiments, the approvers can view messages in any of the child's folders. The child does not have access to any of the folders of the approvers. However, in some embodiments, the child receives notice when messages are rejected and/or when outgoing messages are approved.

The approvers may have additional folders. For example, a message could be moved from an unapproved folder to a “further review” folder, to make it easier to find later, because it contains an attachment that could not be viewed from a particular device, or to flag the message as one that another approver should review.

It should be understood that, although described as separate folders, approver's folders for incoming and outgoing mail may (but need not) overlap in whole or in part. For example, incoming unapproved folder 210 and outgoing unapproved folder 240 may be distinct, with incoming approved and outgoing approved folders 212 and 242 combined as a single folder, and incoming deleted and outgoing deleted folders 214 and 244 also combined as a single folder. As another example, three folders could be used, one for unapproved messages (both incoming and outgoing), one for approved messages (both incoming and outgoing), and one for deleted messages (both incoming and outgoing).

With multiple approvers using different devices to access the mail to be approved, or a single approver using multiple devices, the approvers' (or approver's) devices can be synchronized so that each device has the same messages in the same folders. In some embodiments, this results in each approver only having the ability to approve or reject messages that have not already been approved or rejected on another device and/or by another approver. It should be understood that the current invention is not limited to situations in which some form of synchronization is used or required.

When the child seeks to get new messages, the child only receives messages appearing in approved folder 212. Where there are multiple devices that can be used to approve a message, the child receives only one copy of the approved message. In some embodiments, the child receives an approved message on each device with which mail can be viewed, with the messages synchronized so as to appear in the same folders when viewed from different devices.

If one approver approves a message and another approver rejects a message before the two approvers have synchronized the message (in embodiments where this can occur), or the same approver has both approved and rejected the message from two different devices before the devices have synchronized, different rules can be applied. For example, if the message has been both approved and rejected, a “fail-safe” rule would delete the message from the child's mailbox. Alternatively, one approval could be sufficient for the message to remain in the child's mailbox.

As another alternative, some or all messages can require the approval of all of the approvers. According to one way to implement this arrangement, two different approved folders would exist: approvedl would indicate approval by the first approver, and approved2 would indicate approval by the second approver. A message would not be passed to the child's unread mail folder until it had been approved by both approvers. As with other embodiments, the internal folder arrangement need not be the same as the manner in which messages are displayed. For example, from the first approver's perspective, a message could remain in the unapproved folder until that approver had approved or rejected the message, or the second approver had rejected the message. If the second approver approved the message, it would remain in the first approver's unapproved folder, optionally with an indicator that the message had been approved by the other approver. If the second approver rejected the message, in this implementation, the message would be moved to the deleted folder once the approvers synchronized (which could be immediately).

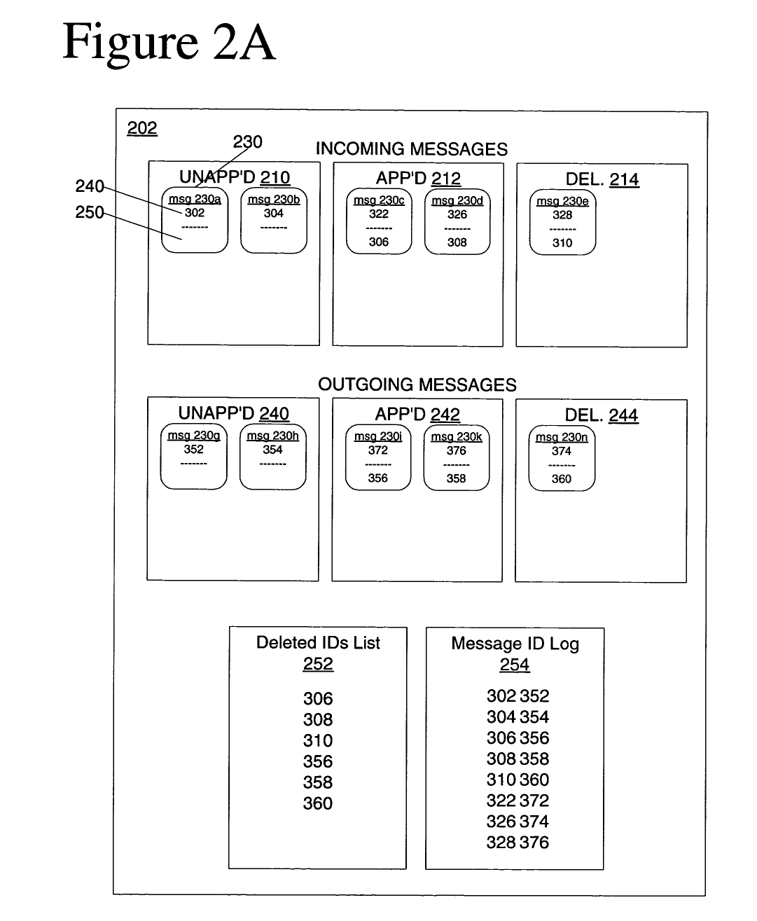

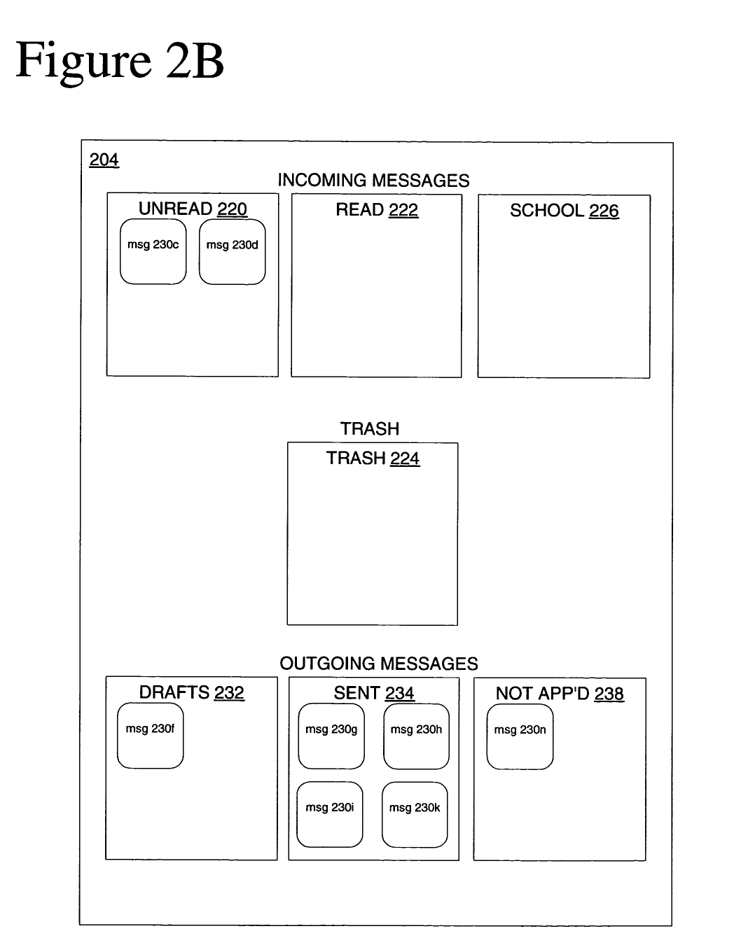

FIG. 2A illustrates some messages in the folders of an approver and FIG. 2B illustrates the messages in the child's folders at the same time, in accordance with an example embodiment of the invention.

In this example, an approver's device 202 has unapproved folder 210, approved folder 212, and deleted folder 214 for incoming messages, and unapproved folder 240, approved folder 242, and deleted folder 244 for outgoing messages. The child's device 204 has unread folder 220, read folder 222, and school folder 226 for incoming messages, and drafts folder 232, sent folder 234, and not approved folder 238 for outgoing messages. In addition, the child's device has trash folder 224. Generally, incoming messages that are approved, and appear in folder 212, also appear in the child's unread folder 220. Likewise, outgoing messages that have been “sent” by the child will appear both in sent folder 232 and in unapproved folder 240.

A number of messages 230 are depicted in this example. Messages 230a and 230b appear in the approver's unapproved incoming folder 210; messages 230c and 230d appear in the approved incoming folder and also in the child's unread messages folder 220. Message 230e appears in incoming deleted folder 214, indicating that it was reviewed and not approved. Consequently, message 230e does not appear anywhere on the child's device 204. Messages 230g and 230h appear in the approver's unapproved outgoing folder and also in the child's sent folder 232. Messages 230i and 230k appear in approved outgoing folder 242 and in the child's sent folder 232. Because these messages have been approved, they have been or will be sent. Message 230n appears in deleted outgoing folder 244, indicating that it was reviewed and not approved. Consequently, message 230n, in this embodiment, also appears in the child's not approved folder 238, thereby allowing the child to know that message 230n was not transmitted to the intended recipient. Finally, message 230f appears in the child's drafts folder, representing a message that has not yet been sent. Consequently, it does not yet appear in the approver's folders.

Each message 230 has, in some embodiments, a message identifier 240 and may have a list of subsidiary identifiers 250. A message identifier 240 may be unique for the electronic mail system as a whole, or for messages for a particular child. In some embodiments, the message identifier is unique only for the current universe of messages. In some embodiments, once a message has been removed from the system or is no longer being synchronized, its message identifier can be reused.

In some embodiments, the message identifier 240 is generated using a Universal Unique Identifier (UUID) algorithm, with the message identifier including a timestamp and the IP address of the device at which the message identifier is generated. This ensures that two or more devices will not assign the same message identifier. Alternatively, other algorithms for generating a unique identifier can be used. Although depicted as a single field, the message identifier can be based on a combination of multiple fields or pieces of data.

When a message is moved from one folder to another (at least within the approval system, and in some embodiments within both the approval system and the child's system), it is assigned a new message identifier. Its prior message identifier is added to a list of subsidiary identifiers 250, which can be used to permit the system to synchronize messages on different devices and to track the history of a message. Optionally, the list of subsidiary identifiers for a message can be cleared if, for example, the system is fully synchronized with respect to that message, or a sufficient period of time has elapsed since the last change to the message.

As shown in FIG. 2A, deleted message identifiers list 252 maintains a list of message identifiers that have been deleted. In some embodiments, message identifiers can be removed from deleted message identifiers list 252 once a synchronization involving that deleted message identifier has occurred on all the approver devices. Alternatively, deleted message identifiers list 252 can be pruned so that only relatively recent additions to the list are maintained. For example, once a message identifier has been in deleted message identifiers list 252 for two months, it may be removed from the list. Depending on the needs of the system, the period can be much shorter or any other appropriate time period.

Message identifier log 254 maintains a list of all message identifiers known to the device, both from generating a message identifier and from learning of the message identifier following a synchronization operation. Alternatively, message identifier log 254 can be more restrictive. It could, for example, maintain only a list of message identifiers that have not been deleted and/or only a list of message identifiers generated on that device. As with deleted message identifiers list 252, message identifier log 254 also can be limited to relatively current messages.

Deleted message identifiers list 252 can take various forms and can include a variety of information. In addition to the list of message identifiers, deleted message identifiers list 252 can include, for example, information about the messages corresponding to those message identifiers. In some embodiments, deleted message identifiers list 252 includes information about the folder in which the message existed when its message identifier changed, or information about each folder in which the message existed. Similarly, the subsidiary identifier list for a message could include information about the folder in which the message existed when its message identifier changed, or information about each folder in which the message existed. The folder information could be obtained using, for example, an additional field or by assigning message identifiers so that they also identify the folder.

Deleted message identifiers list 252 and/or message identifier log 254 may be omitted in some embodiments, or other appropriate structures may be used to permit (when desired) synchronization of messages.

In this example, message 230a has the message identifier value 302 and message 230b has the message identifier value 304. Message 230c has the message identifier value 322 and subsidiary identifier value 306, which represents the message identifier value it had when in unapproved folder 210. Similarly, message 230d has message identifier value 326 and subsidiary identifier value 308. The message identifier values 306 and 308 appear in deleted identifiers list 252, because they no longer represent current message identifiers. Message 230e, in deleted outgoing folder 214, has message identifier value 328 and subsidiary identifier value 310 (which also appears in deleted identifiers list 252). Similarly, messages 230i, 230k, and 230n each has both a current message identifier and a message identifier in the subsidiary identifier list.

Optionally, messages on the child's device are part of the same message identifier system, and also carry message identifiers. This permits the same kind of synchronization for the child. For example, by synchronizing the mail on multiple devices, such as a computer at home, at school, and/or a wireless device, the child can see the same messages in the same folders on those devices.

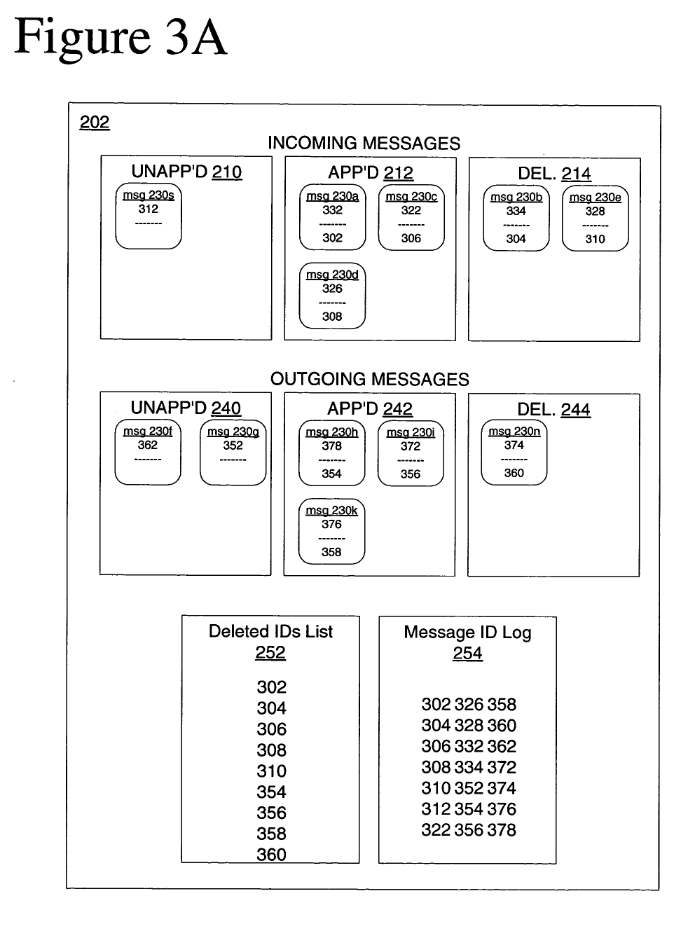

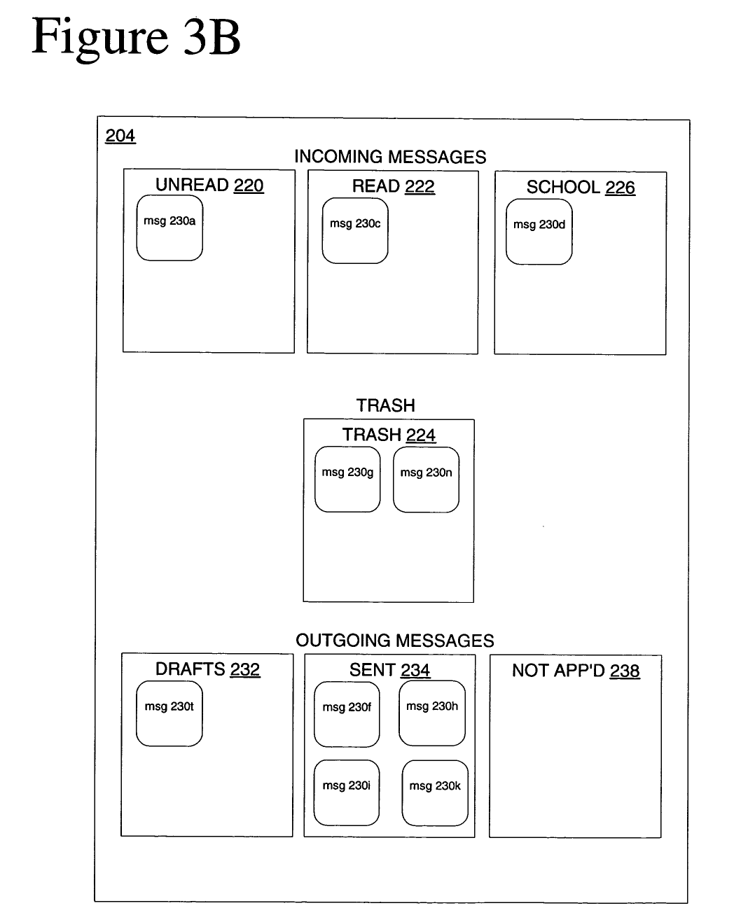

FIGS. 3A and 3B depict devices 202 and 204 at a later time, after some mail activity. In this example, messages 230a and 230b, which had been unapproved, have now been processed by the approver.

Incoming message 230a has been approved, and has a new message identifier value (332), and its old message identifier value (302) now appears as a subsidiary identifier in FIG. 3A. Because message 230a has been approved, it now appears in the child's incoming messages folders in FIG. 3B. In this example, it has not yet been read and appears in unread folder 220.

Message 230b has been rejected, and appears in deleted folder 214 in FIG. 3A with a new message identifier. Because message 230b has been rejected, it does not appear in the child's folders.

Newly received message 230s appears in unapproved folder 210, where it has not yet been approved or rejected. Consequently, it does not appear in the child's folders.

The child has sent message 230f, so it now appears in the child's sent folder 234 and in the approver's unapproved folder 240. In unapproved folder 240, message 230f has a message identifier value 362.

Optionally, messages in one or more of the approved folders and/or messages in one or more of the deleted folders for the approver can be removed automatically after a certain amount of time. Or, they can be moved automatically to one or more archival folders. Alternatively, messages could be moved or removed within the authorizer's folders manually.

Some or all of the information depicted in FIG. 2A may be presented to an approver using a variety of interfaces. Likewise, some or all of the information depicted in FIG. 2B may be presented to a user through a variety of interfaces.

The present invention may be implemented in a variety of forms, such as in software or firmware, running on a general purpose computer or a specialized device. The code can be provided in any machine-readable medium, including magnetic or optical disk, or in memory.

While there have been shown and described examples of the present invention, it will be readily apparent to those skilled in the art that various changes and modifications may be made without departing from the scope of the invention as defined by the following claims. Accordingly, the invention is limited only by the following claims and equivalents thereto.

1. A method for operating an electronic messaging system comprising:
routing an electronic message intended for a first user to a first folder not associated with the first user, instead of to the first user;
presenting the electronic message to a first approver to approve or reject the message;
if delivery of the electronic message to the first user is approved, routing the electronic message to a second folder not associated with the first user and to the first user; and
if delivery of the electronic message to the first user is rejected, routing the electronic message to a third folder not associated with the first user and not to the first user.

2. The method of claim 1, further comprising applying a filter to the electronic message, such that the electronic message is approved if the electronic message passes the filter.

3. The method of claim 1, further comprising applying a filter to the electronic message, such that the electronic message is rejected if the electronic message passes the filter.

4. The method of claim 1, further comprising presenting the electronic message to a second approver to approve or reject the message.

5. The method of claim 4, further comprising displaying to the first approver and to the second approver representations of electronic messages that have been presented for approval.

6. The method of claim 5, further comprising synchronizing the display to the first approver and the display to the second approver of representations of electronic messages that have been presented for approval.

7. A method of operating an electronic messaging system comprising:
directing an outgoing electronic message having an intended recipient sent by a first user to a first folder not associated with the first user, instead of to the intended recipient;
presenting the electronic message to a first approver to approve or reject the message;
if delivery of the electronic message to the intended recipient is approved, routing the electronic message to a second folder not associated with the first user and to the intended recipient; and
if delivery of the electronic message to the intended recipient is rejecting, routing the electronic message to a third folder not associated with the first user and not to the intended recipient.

8. The method of claim 7, further comprising, if delivery of the electronic message to the intended recipient is approved, sending a notification to the first user.

9. A computer program product, residing on a computer-readable medium, for use in operating an electronic messaging system, the computer program product comprising instructions for causing a computer to:
route an incoming electronic message intended for a first user to a first folder not associated with the first user, instead of to the first user;
if delivery of the incoming electronic message is approved, route the incoming electronic message to a second folder not associated with the first user and to the first user;
if delivery of the incoming electronic message is rejected, route the incoming electronic message to a third folder not associated with the first user and not to the first user;
direct an outgoing electronic message having an intended recipient sent by the first user to a fourth folder not associated with the first user, instead of to the intended recipient;
if delivery of the electronic message to the intended recipient is approved, route the electronic message to a fifth folder not associated with the first user and to the intended recipient; and
if delivery of the electronic message to the intended recipient is rejecting, route the electronic message to a sixth folder not associated with the first user and not to the intended recipient.

10. The method of claim 9, wherein the computer program product further comprises instructions for causing a computer to synchronize a first display of messages for the first user at a first location with a second display of messages for the first user at a second location.

11. The method of claim 9, wherein the sixth folder is the same as the third folder.

12. The method of claim 9, wherein the fourth folder is the same as the first folder.

13. The method of claim 9, wherein the fifth folder is the same as the second folder.
